(19) United States
(12) Patent Application Publication
(10) Pub. No.: US 2025/0290903 A1
(43) Pub. Date: Sep. 18, 2025

(54) MASS SPECTROMETRY METHOD, AND ICP MASS SPECTROMETRY DEVICE

(71) Applicant: SHIMADZU CORPORATION, Kyoto (JP)

(72) Inventor: Sachiko WAKASUGI, Kyoto (JP)

(73) Assignee: SHIMADZU CORPORATION, Kyoto (JP)

(21) Appl. No.: 18/688,783

(22) PCT Filed: Mar. 4, 2022
(86) PCT No.: PCT/JP2022/009425

§ 371 Date: Sep. 5, 2024

(30) Foreign Application Priority Data
Sep. 7, 2021 (JP) 2021-145235

(51) Int. Cl. G01N 30/72; G01N 30/02; G01N 30/86; H01J 49/10

(52) U.S. Cl. CPC G01N 30/7233; G01N 30/8624; H01J 49/105; G01N 2030/027

(57) ABSTRACT

In a sample introduction step, a liquid sample is introduced into an ICP mass spectrometry device via a liquid chromatograph. In an internal standard element introduction step, a solution of an internal standard element is mixed with the liquid sample introduced in the sample introduction step without interposing the liquid chromatograph to introduce the internal standard element. In a first chromatogram acquisition step, a first chromatogram 81 is acquired by mass spectrometry for each component in the liquid sample introduced in the sample introduction step. In a second chromatogram acquisition step, a second chromatogram 82 is acquired by mass spectrometry for the internal standard element introduced in the internal standard element introduction step. In a first correction step, the first chromatogram 81 is corrected using the second chromatogram 82.

### TECHNICAL FIELD

The present invention relates to a mass spectrometry method and an ICP mass spectrometry device.

### BACKGROUND ART

In an ICP (Inductively Coupled Plasma) mass spectrometry device, elements in a liquid sample are ionized using plasma generated by inductive coupling, and mass spectrometry is performed on the ionized elements, whereby qualitative and quantitative determination of the elements can be performed with high sensitivity. However, in the ICP mass spectrometry device, a chemical form of each component in the liquid sample cannot be separated and analyzed.

For example, when an arsenic compound is analyzed as a target component, it is known that an inorganic arsenic compound is generally more toxic than an organic arsenic compound, and a trivalent arsenic compound is more toxic than a pentavalent arsenic compound. As described above, since the toxicity of the arsenic compound varies depending on the chemical form, it is preferable to separate and analyze the chemical form of the target component.

Therefore, a mass spectrometry method using a configuration (LC-ICPMS) in which a liquid sample is introduced into an ICP mass spectrometry device via a liquid chromatograph is known (refer to, for example, Patent Document 1 below). According to such a configuration, it is possible to separate the chemical form of the target component in the liquid sample using the liquid chromatograph and then perform mass spectrometry for each chemical form.

### PRIOR ART DOCUMENTS

### Patent Documents

Patent Document 1: WO 2019/198811 A

### SUMMARY OF THE INVENTION

### Problems to be Solved by the Invention

However, the target component in the liquid sample introduced into the ICP mass spectrometry device may be affected by a variation in ionization efficiency in the plasma or a variation in behavior in the mass spectrometer. In this case, since an error occurs in the measurement result, it is preferable that the error can be corrected.

The present invention has been made in view of the above circumstances, and an object thereof is to provide a mass spectrometry method and an ICP mass spectrometry device capable of correcting a measurement error occurring in the ICP mass spectrometry device.

### Means for Solving the Problems

A first aspect of the present invention is a mass spectrometry method including a sample introduction step, an internal standard element introduction step, a first chromatogram acquisition step, a second chromatogram acquisition step, and a first correction step. In the sample introduction step, a liquid sample is introduced into the ICP mass spectrometry device via the liquid chromatograph. In the internal standard element introduction step, a solution of an internal standard element is mixed with the liquid sample introduced in the sample introduction step without interposing the liquid chromatograph to introduce the internal standard element. In the first chromatogram acquisition step, a first chromatogram is acquired by mass spectrometry for each component in the liquid sample introduced in the sample introduction step. In the second chromatogram acquisition step, a second chromatogram is acquired by mass spectrometry for the internal standard element introduced in the internal standard element introduction step. In the first correction step, the first chromatogram is corrected using the second chromatogram.

A second aspect of the present invention is an ICP mass spectrometry device into which a liquid sample is introduced through a liquid chromatograph, and the ICP mass spectrometry device includes an internal standard element introduction unit, a first chromatogram acquisition processing unit, a second chromatogram acquisition processing unit, and a first correction processing unit. The internal standard element introduction unit introduces an internal standard element by mixing a solution of the internal standard element into the liquid sample introduced from the liquid chromatograph without interposing the liquid chromatograph. The first chromatogram acquisition processing unit acquires a first chromatogram by mass spectrometry for each component in a liquid sample introduced from the liquid chromatograph. The second chromatogram acquisition processing unit acquires a second chromatogram by mass spectrometry of an internal standard element introduced from the internal standard element introduction unit. The first correction processing unit corrects the first chromatogram using the second chromatogram.

### Effects of the Invention

According to the present invention, it is possible to correct a measurement error generated in the ICP mass spectrometry device.

### BRIEF DESCRIPTION OF THE DRAWINGS

FIG. 1 is a block diagram illustrating an embodiment of an LC-ICP mass spectrometry device.

FIG. 2 is a block diagram illustrating an example of an electrical configuration of the LC-ICP mass spectrometry device.

FIG. 3 is a diagram for explaining a specific example of correction process.

FIG. 4 is a diagram for explaining a specific example of correction process.

FIG. 5 is a flowchart for explaining each step of mass spectrometry.

### MODE FOR CARRYING OUT THE INVENTION

### 1. Overall Configuration of LC-ICP Mass Spectrometry Device

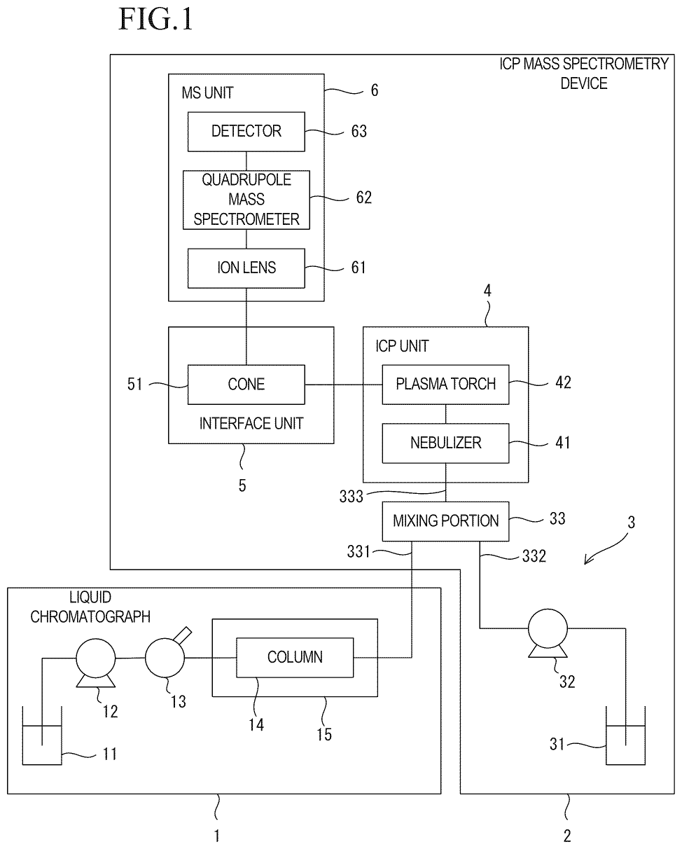

FIG. 1 is a block diagram illustrating an embodiment of the LC-ICP mass spectrometry device. The LC-ICP mass spectrometry device is an apparatus in which a liquid chromatograph 1 and an ICP mass spectrometry device 2 are combined, and a liquid sample is introduced into the ICP mass spectrometry device 2 via the liquid chromatograph 1.

The liquid chromatograph 1 includes a mobile phase storage unit 11, a first pump 12, a sample injection device 13, a column 14, a column oven 15, and the like. The mobile phase storage unit 11 stores a mobile phase made of a liquid such as an organic solvent. The mobile phase in the mobile phase storage unit 11 is fed by driving of the first pump 12 and supplied to the column 14. The first pump 12 is, for example, a liquid feeding pump including a high-pressure pump, and the mobile phase is fed from the mobile phase storage unit 11 at a constant flow rate.

A liquid sample is injected from the sample injection device 13 into the mobile phase supplied to the column 14 at an optional timing. As a result, the liquid sample is supplied to the column 14 together with the mobile phase. The column 14 is accommodated in the column oven 15. The inside of the column oven 15 is heated by a heater (not shown), and each component in the liquid sample is temporally separated in the process in which the liquid sample passes through the column 14 heated in the column oven 15 together with the mobile phase.

The liquid sample that has passed through the column 14 is introduced into the ICP mass spectrometry device 2 in a state where each component in the liquid sample is separated. That is, each component in the separated liquid sample is sequentially introduced from the liquid chromatograph 1 to the ICP mass spectrometry device 2.

In the present embodiment, a plurality of types of components having the same element and different chemical forms are contained in the liquid sample. For example, when a target element to be analyzed is arsenic (As), its chemical form is roughly classified into an inorganic arsenic compound and an organic arsenic compound. Examples of the inorganic arsenic compound include arsenous acid (As³⁺) which is a trivalent arsenic compound and arsenous acid (As⁵⁺) which is a pentavalent arsenic compound.

The organic arsenic compounds include arsenic metabolites and sea-product-derived arsenic compounds. Examples of the arsenic metabolites include DMA (dimethylarcinic acid as a trivalent arsenic compound or dimethylarcinic acid as a pentavalent arsenic compound) and MMA (monomethylarsonic acid as a trivalent arsenic compound or monomethylarsonic acid as a pentavalent arsenic compound). Examples of the sea-product-derived arsenic compounds include AB (arsenobetaine).

The ICP mass spectrometry device 2 includes an internal standard element introduction unit 3, an ICP unit 4, an interface unit 5, an MS unit 6, and the like. In the present embodiment, by interposing the internal standard element introduction unit 3 in the middle of the pipe connecting the liquid chromatograph 1 and the ICP mass spectrometry device 2, a solution of an internal standard element (internal standard solution) can be mixed with the liquid sample introduced from the liquid chromatograph 1 to the ICP mass spectrometry device 2.

The internal standard element introduction unit 3 includes an internal standard solution storage portion 31, a second pump 32, a mixing portion 33, and the like. The internal standard solution is stored in the internal standard solution storage portion 31. Examples of the internal standard element contained in the internal standard solution include gallium (Ga), selenium (Se), tellurium (Te), and the like, but are not limited thereto. As the internal standard element, an element having no isotope or an element having a large isotope ratio is preferably used.

In the present embodiment, a case where the target element is arsenic (As), and mass spectrometry is performed using a plurality of components having different chemical forms as target components for the target element will be described. Here, arsenic (As) is ⁷⁵As as a stable isotope. In this case, an element having a mass close to that of arsenic (As) as a target element or an element having ionization efficiency close to that of arsenic (As) is preferably selected as an internal standard element. When the fluctuation in the plasma is large, an element having close ionization efficiency is preferable, and when the fluctuation in the convergence of ions after passing through the plasma is large, an element having close mass is preferably selected. When ⁷¹Ga, which is a stable isotope, is used as an internal standard element, the mass is preferably close to that of ⁷⁵As, which is a target element. In addition, it is important that the internal standard element is not contained in the actual sample or is contained in a trace amount that can be ignored with respect to the added amount.

The internal standard solution in the internal standard solution storage portion 31 is fed by driving of the second pump 32 and supplied to the mixing portion 33. The second pump 32 is, for example, a liquid feeding pump configured by a tube pump. The tube pump is a pump of a type in which an elastic tube is squeezed with a roller to extrude a liquid in the tube, and can accurately feed the liquid at a constant flow rate. As described above, it is preferable to use a pump capable of accurately feeding a liquid at a constant flow rate as the second pump 32.

A first pipe 331 communicating with the column 14 of the liquid chromatograph 1, a second pipe 332 communicating with the second pump 32, and a third pipe 333 communicating with the ICP unit 4 are connected to the mixing portion 33. An inner diameter of the third pipe 333 is the same as the inner diameters of the first pipe 331 and the second pipe 332. A T-shaped flow path is formed in the mixing portion 33, the liquid flowing in from the first pipe 331 and the liquid flowing in from the second pipe 332 are mixed in the mixing portion 33, and the mixed liquid flows out from the third pipe 333.

According to the internal standard element introduction unit 3 having such a configuration, the internal standard solution is mixed at a constant flow rate from the second pipe 332 to the liquid sample introduced from the liquid chromatograph 1 to the ICP unit 4 through the first pipe 331 and the third pipe 333 without interposing the liquid chromatograph 1. As a result, a liquid sample (mixed liquid) containing the internal standard element can be introduced into the ICP unit 4. Note that the constant flow rate may be, for example, a constant set flow rate of the second pump 32, and a case where the actual flow rate slightly fluctuates is also included in the concept of the constant flow rate.

The ICP unit 4 functions as an ion source that ionizes elements in the liquid sample using plasma generated by inductive coupling. The ICP unit 4 includes a nebulizer 41, a plasma torch 42, and the like.

The nebulizer 41 atomizes the mixed liquid introduced from the mixing portion 33. As a result, the atomized (aerosol) mixed liquid is supplied to the plasma torch 42 together with a carrier gas. A plasma gas is supplied to the plasma torch 42 in addition to the atomized mixed liquid. The carrier gas and the plasma gas are, for example, argon gas.

In the plasma torch 42, plasma gas is ionized by a high-frequency electromagnetic field formed by an induction coil (not shown) to generate plasma. By injecting the atomized mixed liquid together with the carrier gas to the plasma generated in this manner, the elements in the mixed liquid are ionized. The element ionized in the ICP unit 4 is introduced into the MS unit 6 via the interface unit 5.

The interface unit 5 includes a cone 51 including, for example, a sampling cone and a skimmer cone. The cone 51 is a metal member formed in a conical shape, and has a minute hole (orifice) having an inner diameter of about several mm. The element ionized in the ICP unit 4 passes through the orifice of the cone 51 and then is introduced into the MS unit 6.

The MS unit 6 includes, for example, an ion lens 61, a quadrupole mass spectrometer 62, a detector 63, and the like in a housing that is brought into a vacuum state by a vacuum pump (not shown). The MS unit 6 performs mass spectrometry on the ionized element introduced from the ICP unit 4 to the MS unit 6 via the interface unit 5, whereby a chromatogram can be acquired.

The ion lens 61 converges the ionized element that passes through the cone 51 and is introduced into the MS unit 6, and makes the element enter the quadrupole mass spectrometer 62. The quadrupole mass spectrometer 62 is an example of a mass spectrometer, and separates ions incident from the ion lens 61 for each mass. However, the mass spectrometer is not limited to the quadrupole mass spectrometer 62, and may be a mass spectrometer of another type such as a double-convergence type. As the mass spectrometer, a magnetic field mass spectrometer, a time-of-flight mass spectrometer, or the like may be used.

The detector 63 detects ions separated for each mass in the quadrupole mass spectrometer 62 and outputs a signal corresponding to the detection intensity. The chromatogram can be acquired based on the output signal from the detector 63. For example, the total ion current (TIC) chromatogram can be acquired by adding up the intensities of all the ions detected with the lapse of time. A mass chromatogram (MC) can be obtained by extracting only the intensity of a specific mass detected with the lapse of time.

### 2. Electrical Configuration of LC-ICP Mass Spectrometry Device

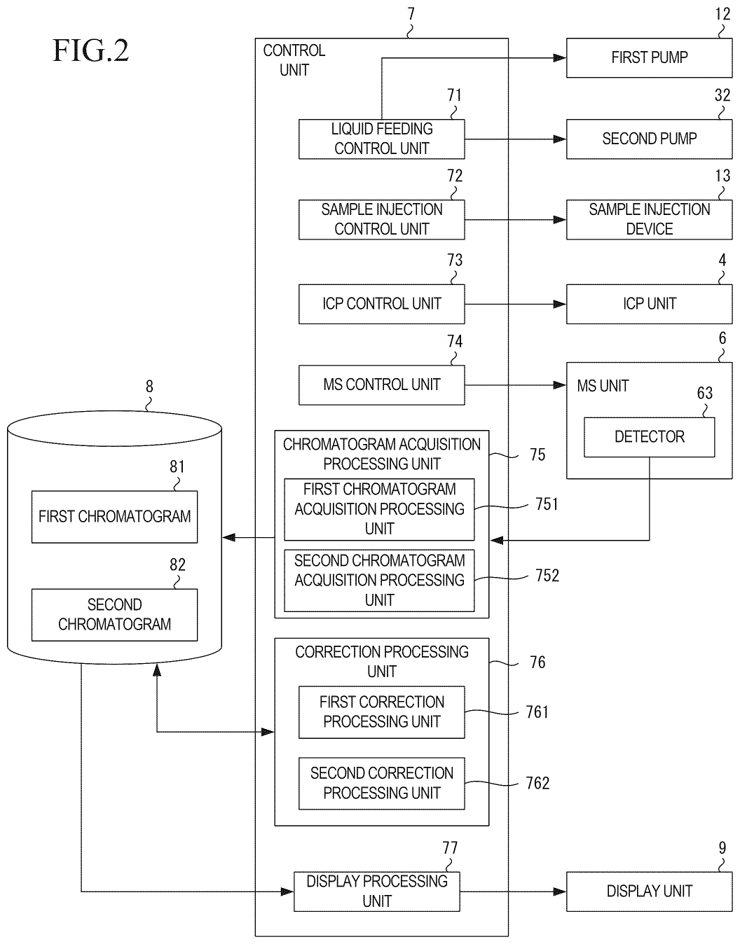

FIG. 2 is a block diagram illustrating an example of the electrical configuration of the LC-ICP mass spectrometry device. The operation of the LC-ICP mass spectrometry device is controlled by a control unit 7 including a processor including, for example, a CPU (Central Processing Unit).

The LC-ICP mass spectrometry device includes a storage unit 8 and a display unit 9 electrically connected to the control unit 7 in addition to the control unit 7. The storage unit 8 includes, for example, a ROM (Read Only Memory), RAM (Random Access Memory), or a hard disk, and stores data necessary for control in addition to a computer program. The display unit 9 includes, for example, a liquid crystal display.

When the processor executes a computer program, the control unit 7 functions as a liquid feeding control unit 71, a sample injection control unit 72, an ICP control unit 73, an MS control unit 74, a chromatogram acquisition processing unit 75, a correction processing unit 76, a display processing unit 77, and the like. The first pump 12, the second pump 32, the sample injection device 13, the ICP unit 4, the MS unit 6, and the like are electrically connected to the control unit 7.

The liquid feeding control unit 71 controls the operations of the first pump 12 and the second pump 32. Specifically, the liquid feeding control unit 71 controls the operation of the first pump 12 to control the flow rate of the mobile phase supplied from the mobile phase storage unit 11 to the column 14. In addition, the liquid feeding control unit 71 controls the operation of the second pump 32 to control the flow rate of the internal standard solution supplied from the internal standard solution storage portion 31 to the mixing portion 33.

The sample injection control unit 72 controls the sample injection device 13 to inject the liquid sample into the mobile phase before being supplied to the column 14 at a predetermined timing. The injection timing of the liquid sample may be a predetermined constant timing or a timing optionally set by the user.

The ICP control unit 73 controls the operation of the ICP unit 4. Specifically, the ICP control unit 73 controls the generation of plasma by controlling the energization to the induction coil and controlling the supply of the carrier gas and the plasma gas.

The MS control unit 74 controls the operation of the MS unit 6. Specifically, the MS control unit 74 controls the operation of the vacuum pump to control the inside of the housing of the MS unit 6 to a vacuum state, and controls energization to each unit such as the quadrupole mass spectrometer 62.

The output signal from the detector 63 of the MS unit 6 is input to the control unit 7, and the chromatogram is acquired by the chromatogram acquisition processing unit 75 based on the output signal. The chromatogram acquisition processing unit 75 includes a first chromatogram acquisition processing unit 751 and a second chromatogram acquisition processing unit 752.

The first chromatogram acquisition processing unit 751 acquires a first chromatogram 81 by mass spectrometry of each component in the liquid sample introduced from the liquid chromatograph 1 among the mixed liquids introduced into the ICP unit 4. The first chromatogram 81 acquired by the first chromatogram acquisition processing unit 751 is stored in the storage unit 8.

Each component in the liquid sample becomes an element ionized in the ICP unit 4, and mass spectrometry is performed in the MS unit 6. For example, when arsenous acid (As³⁺), arsenous acid (As⁵⁺), DMA, MMA, and arsenobetaine (AB), which are different chemical forms of arsenic (As), are contained as respective components in the liquid sample, the MS unit 6 performs mass spectrometry on arsenic ions, which are ions of the same element obtained from the respective components in the ICP unit 4.

As described above, even when ions of the same element are obtained from each component in the liquid sample in the ICP unit 4, since each component is temporally separated in advance in the liquid chromatograph 1, a peak is detected at different retention times for each component (for each chemical form) by mass spectrometry in the MS unit 6. As a result, the first chromatogram acquisition processing unit 751 can acquire a TIC chromatogram including a peak for each chemical form as the first chromatogram 81.

A component corresponding to any one of the peaks included in the first chromatogram is an internal standard component for correcting a peak for another component. For example, when arsenobetaine (AB) is used as an internal standard component, peaks of other components such as arsenous acid (As³⁺), arsenous acid (As⁵⁺), DMA, or MMA can be corrected using the height or area of the peak. The internal standard component has an element different from the internal standard element (for example, gallium (Ga), selenium (Se), tellurium (Te), or the like) contained in the internal standard solution stored in the internal standard solution storage portion 31.

The second chromatogram acquisition processing unit 752 acquires the second chromatogram 82 by mass spectrometry with respect to the internal standard element introduced from the internal standard element introduction unit 3 among the mixed liquids introduced into the ICP unit 4. The second chromatogram 82 acquired by the second chromatogram acquisition processing unit 752 is stored in the storage unit 8.

For example, when the internal standard element contained in the internal standard solution is gallium (Ga), mass spectrometry is performed in the MS unit 6 for gallium ions obtained in the ICP unit 4. Therefore, the second chromatogram acquisition processing unit 752 can acquire the mass chromatogram for gallium (Ga) as the second chromatogram 82 by extracting only the intensity of the mass corresponding to the gallium ion.

The correction processing unit 76 includes a first correction processing unit 761 and a second correction processing unit 762. The first correction processing unit 761 performs arithmetic processing of correcting the first chromatogram 81 using the second chromatogram 82. In addition, the second correction processing unit 762 performs arithmetic processing of correcting the peak of the target component included in the first chromatogram 81 corrected by the first correction processing unit 761 with the peak of the internal standard component included in the first chromatogram 81. Specific arithmetic processing by the first correction processing unit 761 and the second correction processing unit 762 will be described later.

The data of the first chromatogram 81 corrected by the first correction processing unit 761 and the second correction processing unit 762 is stored in the storage unit 8. The display processing unit 77 can read the data of the first chromatogram 81 corrected by the first correction processing unit 761 and the second correction processing unit 762 from the storage unit 8 and display the data on the display unit 9. It is also possible to create a calibration curve using the data of the corrected first chromatogram 81.

### 3. Specific Example of Correction Processing

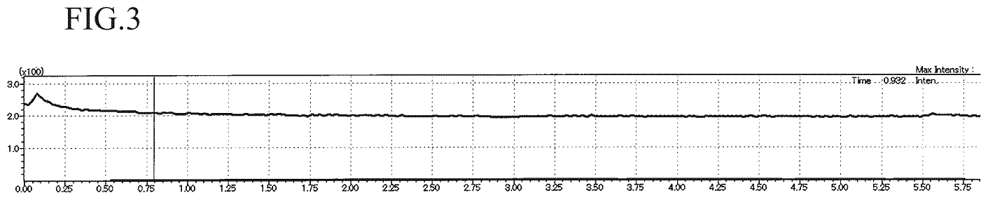

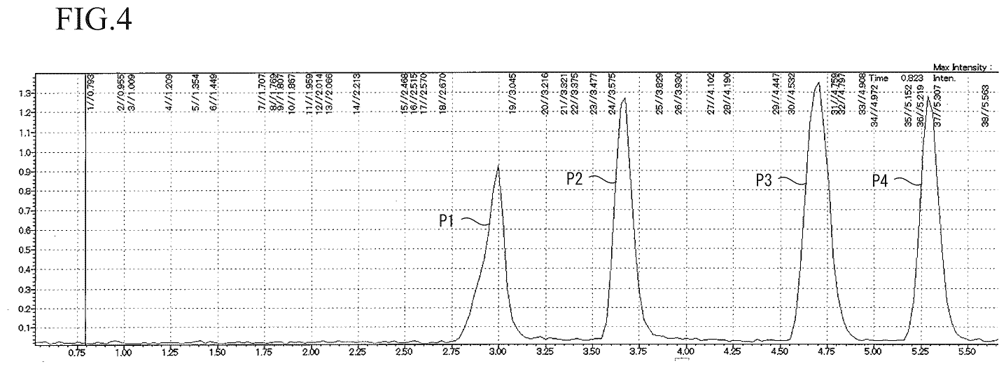

FIGS. 3 and 4 are diagrams for explaining a specific example of correction process. FIG. 3 is an example of the second chromatogram 82 acquired by mass spectrometry with respect to gallium (Ga) as an internal standard element. On the other hand, FIG. 4 illustrates a result obtained by correcting the first chromatogram 81 acquired by mass spectrometry for a liquid sample containing each component of arsenous acid (As³⁺), arsenous acid (As⁵⁺), DMA, and arsenobetaine (AB) using the second chromatogram 82 of FIG. 3.

In the present embodiment, since the solution of the internal standard element is mixed with the liquid sample at a constant flow rate, the second chromatogram 82 having substantially constant intensity is obtained as illustrated in FIG. 3. The first correction processing unit 761 corrects the first chromatogram 81 by dividing the intensity value at each time of the first chromatogram 81 by the intensity value corresponding to the same time in the second chromatogram 82. That is, for the intensity value (first intensity value) of the first chromatogram 81 and the intensity value (second intensity value) of the second chromatogram 82 at the same retention time, the first intensity value is divided by the second intensity value, whereby the first chromatogram 81 is corrected.

The chromatogram in FIG. 4, which is a result of correcting the first chromatogram 81 using the second chromatogram 82, includes a peak P1 of arsenous acid (As⁵⁺), a peak P2 of arsenous acid (As³⁺), a peak P3 of DMA, and a peak P4 of arsenobetaine (AB). The second correction processing unit 762 corrects the peaks P1, P2, and P3 of the target component included in the first chromatogram 81 corrected by the first correction processing unit 761 illustrated in FIG. 4 with the peak P4 of the internal standard component included in the first chromatogram 81.

Specifically, the intensity values (peak heights) of the peak P1 of arsenous acid (As⁵⁺), the peak P2 of arsenous acid (As³⁺), and the peak P3 of DMA are divided by the intensity value (peak height) of the peak P4 of arsenobetaine (AB) as an internal standard component. However, it is also possible to perform correction using the area of the peak instead of the intensity value (peak height) of the peak. That is, the area of the peak P1 of arsenous acid (As⁵⁺), the peak P2 of arsenous acid (As³⁺), and the peak P3 of DMA may be divided by the area of the peak P4 of arsenobetaine (AB) as an internal standard component.

In this example, a case where the target component is arsenic acid (As⁵⁺), arsenous acid (As³⁺), and DMA, and the internal standard component is arsenobetaine (AB) has been described, but the present invention is not limited thereto. That is, the target component may not contain at least one of arsenous acid (As⁵⁺), arsenous acid (As³⁺), and DMA, or may contain other components. The internal standard component may be a component other than arsenobetaine (AB).

### 4. Mass Spectrometry Flow

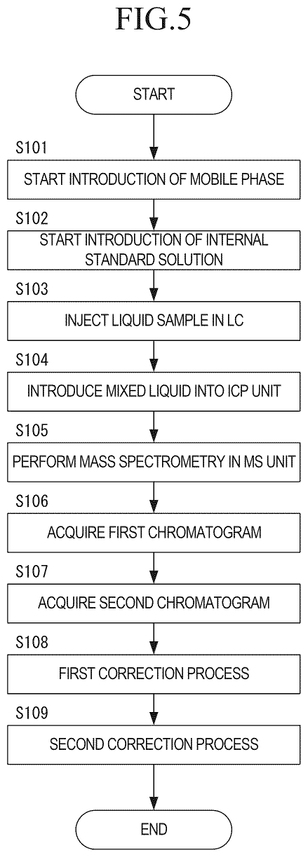

FIG. 5 is a flowchart for explaining each step of mass spectrometry. When the user performs an operation of instructing the LC-ICP mass spectrometry device to start mass spectrometry, first, the first pump 12 of the liquid chromatograph 1 is driven to continuously introduce the mobile phase into the column 14 (step S101). The mobile phase that has passed through the column 14 is supplied to the mixing portion 33 of the ICP mass spectrometry device 2.

When the second pump 32 of the internal standard element introduction unit 3 is driven, the internal standard solution is continuously introduced from the internal standard element introduction unit 3 into the mixing portion 33 (step S102: internal standard element introduction step). At this time, the internal standard solution is introduced into the mixing portion 33 at a constant flow rate without interposing the liquid chromatograph 1.

When the sample injection device 13 is driven in this state, the liquid sample is injected into the mobile phase introduced into the column 14 (step S103). The liquid sample injected into the mobile phase passes through the column 14, and each component in the liquid sample is separated in the process, then mixed with the internal standard solution in the mixing portion 33, and the mixed liquid is introduced into the ICP unit 4 (step S104: sample introduction step).

In the ICP unit 4, the mixed liquid introduced from the mixing portion 33 is atomized by the nebulizer 41, and the atomized mixed liquid is injected into the plasma, whereby the elements in the mixed liquid are ionized. Then, the ionized element is introduced into the MS unit 6 via the interface unit 5, and mass spectrometry is performed in the MS unit 6 (step S105).

By the mass spectrometry in the MS unit 6, the first chromatogram 81 is acquired (step S106: first chromatogram acquisition step), and the second chromatogram 82 is acquired (step 107: second chromatogram acquisition step). That is, the first chromatogram 81 is acquired by mass spectrometry for each component in the liquid sample, and the second chromatogram 82 is acquired by mass spectrometry for the internal standard element.

Thereafter, a process of correcting the first chromatogram 81 using the acquired second chromatogram 82 is performed (step S108: first correction step). As a result, correction processing is performed using the second chromatogram 82 as exemplified in FIG. 3, and as a result, a corrected first chromatogram 81 as exemplified in FIG. 4 is obtained.

In addition, a process of correcting the peak of the target component included in the corrected first chromatogram 81 with the peak of the internal standard component included in the first chromatogram 81 is performed (step S109: second correction step). In the example of FIG. 4, the peak P1 of arsenous acid (As⁵⁺), the peak P2 of arsenous acid (As³⁺), and the peak P3 of DMA are corrected by the peak P4 of arsenobetaine (AB) which is an internal standard component.

In this way, the first chromatogram 81 subjected to both the first correction process and the second correction process is obtained. The corrected first chromatogram 81 may be stored in the storage unit 8 and displayed on the display unit 9 as necessary. The calibration curve may be created using the data of the corrected first chromatogram 81 stored in the storage unit 8.

### 5. Modification

In the above embodiment, the case where the target element to be analyzed is arsenic (As) has been described. However, the target element may be another element such as mercury (Hg), selenium (Se), or chromium (Cr).

In addition, the number of internal standard elements is not limited to one, and may be plural. For example, not only gallium (Ga) but also other elements such as selenium (Se) or tellurium (Te) may be mixed as internal standard elements in a liquid sample and subjected to mass spectrometry to acquire a plurality of second chromatograms 82, and the second chromatogram 82 corresponding to any of the internal standard elements may be selected to correct the first chromatogram 81.

### 6. Aspects

It is understood by those skilled in the art that the plurality of exemplary embodiments described above are specific examples of the following aspects.

(Aspect 1) A mass spectrometry method according to one aspect includes:
a sample introduction step of introducing a liquid sample into an ICP mass spectrometry device via a liquid chromatograph;
an internal standard element introduction step of introducing an internal standard element by mixing a solution of the internal standard element with the liquid sample introduced in the sample introduction step without interposing the liquid chromatograph;
a first chromatogram acquisition step of acquiring a first chromatogram by mass spectrometry for each component in the liquid sample introduced in the sample introduction step;
a second chromatogram acquisition step of acquiring a second chromatogram by mass spectrometry with respect to the internal standard element introduced by the internal standard element introduction step; and
a first correction step of correcting the first chromatogram using the second chromatogram.

According to the mass spectrometry method described in Aspect 1, the second chromatogram is acquired by mass spectrometry for the internal standard element mixed in the liquid sample, and the first chromatogram acquired by mass spectrometry for each component in the liquid sample can be corrected using the second chromatogram. As a result, it is possible to correct, by using the second chromatogram, a measurement error caused when the target component in the liquid sample is affected by a variation in ionization efficiency in the plasma or a behavior variation in the mass spectrometer.

(Aspect 2) The mass spectrometry method according to Aspect 1, wherein in the first correction step, the first chromatogram may be corrected by dividing an intensity value at each time of the first chromatogram by an intensity value corresponding to the same time in the second chromatogram.

According to the mass spectrometry method described in Aspect 2, the measurement error can be satisfactorily corrected by correcting the error of the intensity value at each time in the first chromatogram using the intensity value corresponding to the same time in the second chromatogram.

(Aspect 3) The mass spectrometry method according to Aspect 1 or 2, wherein
the liquid sample introduced in the sample introduction step contains an internal standard component having an element different from the internal standard element, and
the mass spectrometry method may further include a second correction step of correcting a peak of a target component contained in the first chromatogram corrected by the first correction step with a peak of an internal standard component contained in the first chromatogram.

According to the mass spectrometry method described in Aspect 3, after the chemical form of the target component in the liquid sample is separated using the liquid chromatograph, the peak of the target component contained in the first chromatogram can be corrected with the peak of the internal standard component contained in the first chromatogram. As a result, an error in the injection amount of the liquid sample in the liquid chromatograph and the like can be corrected.

(Aspect 4) The mass spectrometry method according to Aspect 3, wherein in the second correction step, the peak of the target component may be corrected by dividing the intensity value or an area of the peak of the target component contained in the first chromatogram corrected in the first correction step by the intensity value or an area of the peak of the internal standard component contained in the first chromatogram.

According to the mass spectrometry method described in Aspect 4, the intensity value or the area of the peak of the target component contained in the first chromatogram is corrected using the intensity value or the area of the peak of the internal standard component contained in the first chromatogram, whereby the measurement error can be satisfactorily corrected.

(Aspect 5) According to one aspect, an ICP mass spectrometry device into which a liquid sample is introduced via a liquid chromatograph, includes:
an internal standard element introduction unit that introduces an internal standard element by mixing a solution of the internal standard element into a liquid sample introduced from the liquid chromatograph without interposing the liquid chromatograph;
a first chromatogram acquisition processing unit that acquires a first chromatogram by mass spectrometry for each component in a liquid sample introduced from the liquid chromatograph;
a second chromatogram acquisition processing unit that acquires a second chromatogram by mass spectrometry with respect to an internal standard element introduced from the internal standard element introduction unit; and
a first correction processing unit that corrects the first chromatogram using the second chromatogram.

According to the ICP mass spectrometry device described in Aspect 5, the second chromatogram is acquired by mass spectrometry for the internal standard element mixed in the liquid sample, and the first chromatogram acquired by mass spectrometry for each component in the liquid sample can be corrected using the second chromatogram. As a result, it is possible to correct, by using the second chromatogram, a measurement error caused when the target component in the liquid sample is affected by a variation in ionization efficiency in the plasma or a behavior variation in the mass spectrometer.

(Aspect 6) The ICP mass spectrometry device according to Aspect 5, wherein
the liquid sample introduced from the liquid chromatograph contains an internal standard component having an element different from the internal standard element, and
the ICP mass spectrometry device may further include a second correction processing unit that corrects a peak of a target component contained in the first chromatogram corrected by the first correction processing unit with a peak of an internal standard component contained in the first chromatogram.

According to the ICP mass spectrometry device described in Aspect 6, after the chemical form of the target component in the liquid sample is separated using the liquid chromatograph, the peak of the target component contained in the first chromatogram can be corrected with the peak of the internal standard component contained in the first chromatogram. As a result, an error in the injection amount of the liquid sample in the liquid chromatograph and the like can be corrected.

### DESCRIPTION OF REFERENCE SIGNS

1 liquid chromatograph
2 ICP mass spectrometry device
3 internal standard element introduction unit
4 ICP unit
5 interface unit
6 MS unit
7 control unit
81 first chromatogram
82 second chromatogram
751 first chromatogram acquisition processing unit
752 second chromatogram acquisition processing unit
761 first correction processing unit
762 second correction processing unit
P1 to P4 peak

1. A mass spectrometry method comprising:
a sample introduction step of introducing a liquid sample into an ICP mass spectrometry device via a liquid chromatograph;
an internal standard element introduction step of introducing an internal standard element by mixing a solution of the internal standard element with the liquid sample introduced in the sample introduction step without interposing the liquid chromatograph;
a first chromatogram acquisition step of acquiring a first chromatogram by mass spectrometry for each component in the liquid sample introduced in the sample introduction step;
a second chromatogram acquisition step of acquiring a second chromatogram by mass spectrometry with respect to the internal standard element introduced by the internal standard element introduction step; and
a first correction step of correcting the first chromatogram using the second chromatogram.

2. The mass spectrometry method according to claim 1, wherein in the first correction step, the first chromatogram is corrected by dividing an intensity value at each time of the first chromatogram by an intensity value corresponding to the same time in the second chromatogram.

3. The mass spectrometry method according to claim 1 or 2, wherein
the liquid sample introduced in the sample introduction step contains an internal standard component having an element different from the internal standard element, and
the mass spectrometry method further comprises a second correction step of correcting a peak of a target component contained in the first chromatogram corrected by the first correction step with a peak of an internal standard component contained in the first chromatogram.

4. The mass spectrometry method according to claim 3, wherein in the second correction step, the peak of the target component is corrected by dividing the intensity value or an area of the peak of the target component contained in the first chromatogram corrected in the first correction step by the intensity value or an area of the peak of the internal standard component contained in the first chromatogram.

5. An ICP mass spectrometry device into which a liquid sample is introduced via a liquid chromatograph, the apparatus comprising:
an internal standard element introduction unit that introduces an internal standard element by mixing a solution of the internal standard element into a liquid sample introduced from the liquid chromatograph without interposing the liquid chromatograph;
a first chromatogram acquisition processing unit that acquires a first chromatogram by mass spectrometry for each component in a liquid sample introduced from the liquid chromatograph;
a second chromatogram acquisition processing unit that acquires a second chromatogram by mass spectrometry with respect to an internal standard element introduced from the internal standard element introduction unit; and
a first correction processing unit that corrects the first chromatogram using the second chromatogram.

6. The ICP mass spectrometry device according to claim 5, wherein
the liquid sample introduced from the liquid chromatograph contains an internal standard component having an element different from the internal standard element, and
the ICP mass spectrometry device further comprises a second correction processing unit that corrects a peak of a target component contained in the first chromatogram corrected by the first correction processing unit with a peak of an internal standard component contained in the first chromatogram.
